(19) United States
(12) Patent Application Publication
(10) Pub. No.: US 2019/0126135 A1
(43) Pub. Date: May 2, 2019

(54) INTERACTIVE LASER TAG SYSTEM AND A METHOD OF USING THE SAME

(71) Applicant: Smartlab Pte Ltd, Singapore (SG)

(72) Inventor: Tony Lay Thiam TAN, Singapore (SG)

(21) Appl. No.: 16/228,801

(22) Filed: Dec. 21, 2018

Related U.S. Application Data
(62) Division of application No. 14/909,465, filed on Feb. 2, 2016.

(51) Int. Cl. A63F 9/02; A63F 13/214; A63F 13/30; A63F 13/216; A63F 13/219; A63F 13/843

(52) U.S. Cl. CPC A63F 9/0291; A63F 13/214; A63F 13/843; A63F 13/216; A63F 13/219; A63F 13/30

(57) ABSTRACT

An interactive laser tag system for entertaining multiple play participants or players comprising: toy laser weapons for each of the players, capable of transmitting and detecting an IR beam of light for use in a game; a wireless module or data communication linked to communicate with software or apps on a mobile display device for instance, a handphone or a mobile computer, loaded with web-based software; a server for the login of the player of the game; and a Global Positioning System (GPS) use for providing locations of the players, of which the GPS data are made available to the players, wherein the web-based software operating on the mobile display device calculates and determines hit by a player being registered, and plays a sound and visual effects of the toy laser weapons on the mobile display device, and generates a Graphical User Interface that displayable on the mobile display device kept with the players so as to enhance the effects of the game. The present invention also relates to a method of using the laser tag system in a tagging game.

This is a division of the co-pending patent application Ser. No. 14/909,465, filed Feb. 2, 2016.

### BACKGROUND

### 1. Field of the Invention

The present invention relates to play systems and toys, and specifically to interactive laser tag games and toys involving infrared light transmission. The present invention also relates to a method of using the play system and toys.

### 2. Description of the Related Art

There are many games, toys, play structures and other similar entertainment systems that are well known and played interactively among children and adults. A variety of commercially available play toys and games are available to provide both for education and entertainment opportunities for children, for instance, reading, memory stimulation, tactile coordination, stimulations of children's imaginations, creativity and social interactivity, and the like.

While there are many games and toys that interactive and that employed infrared light communications between a plurality of players. For instance, U.S. Pat. No. 5,904,621, entitled “Electronic Game with Infrared (IR) emitter and Sensor” to David Small et al, discloses a system that uses infrared communication. A toy laser tag being a hand-held toy gun and target apparatus are disclosed, and an electronic controller is coupled to a transmitter for sending a series of encoded IR light signals and an IR receiver for detecting IR light signals.

U.S. Pat. No. 7,338,375 entitled “Integrated Voice and Data Communication for Laser Tag System” to David Small discloses a system that uses infrared communication. The toy laser tag gun includes an IR receiver, and IR transmitter, a speaker and a microphone to allow audible sound/voice to be communicated over IR beam or a radio frequency signal while date is communicated over the IR beam or a radio frequency signal while data is communicated over the IR beam. U.S. Pat. No. 7,338,375 discloses solely on laser tag guns and does not disclose other kind of laser tag weapons.

US Patent Publication No. 2001/0024973 entitled “Laser Light Sword” to Christopher Meredith discloses a system using sword for gaming. The laser light sword has a handle having accelerometers, light switch, joystick and micro switch to sense and control movement. The sword does not make use of IR receiver and transmitter.

US Patent Publication No. 20050043102 discloses an electronic game comprising at least two two-way communication information units. The two communication units send out packets of information at predetermined intervals to similar information units. A similar information unit can read the packet and sense that there is another device in the room and alert the user. This feature simulates radar.

U.S. Pat. No. 5,577,962 discloses a gun game machine from which a player takes out and holds a model gun to play a game. When the number of operations of a trigger lever attains the preset number of times, the game is stopped and, at the same time, a solenoid operates to disengage a boss of a lever from a recess of an advance and retreat member and the advance and retreat member is ejected down by the effect of a spring. When the player pushes up the advance and retreat member to set, a sensor detects the pushing action and resets the trigger count value for enabling the game to continue. The action of pushing up the advance and retreat device is similar to the real action of loading a cartridge into a real gun and the player can enjoy a game having realism.

U.S. Pat. No. 4,799,687 discloses a light projection tag game requiring the overlap of player projected images on a gaming surface. Each player is provided with an optical transceiver that has a receiver with a narrow field of view that is geometrically coincident with the light beam projected from the transceiver. Each player's transceiver can detect when an opponent's image that is also projected on the gaming surface enters this field of view thereby achieving a tag. Receiver methods use either signal transients or infrared modulation. Various embodiments include automatic targets, automatic game control, and projected gaming mazes.

However, many of the above listed inventions have certain drawbacks. For instance, existing laser tag games do not provide the use of tag sword, bow, shield and spear in the game play apart from gun. There is also limited effort to make use of technological advancements made in wireless technology like Bluetooth, and acceleration, gyroscopic and magnetic sensors to integrate these technologies with the opportunities bring about by mobile computing and phone to make the gaming experience of laser tag gamers more interesting and challenging. Further, existing laser tag games do not allow any play until the players are in visual contact with each other, as clear lines of sights are required before the IR beams can be shot at each other. Existing laser tag games cannot be effectively played when players get in close range within 5 meters. At very close range, players are tempted to cover their sensors. Effective players at close range are those who can run fast as they shoot, before scurrying away and using their backs and body parts to shield their sensors from IR beams. There is no laser sword that can be used to effectively hit and kill players at close range. The same existing laser tag equipment does not allow any player or players to play against the computer in an IR shoot-out of computer-animated figures including soldiers, warriors, ninjas, robots, aliens and mythical creatures.

Accordingly, the present invention provides an interactive laser tag games and toys involving infrared light transmission which mitigates the above drawbacks.

### SUMMARY OF THE INVENTION

An interactive laser tag games and toys including sword, bow, shield, glove and spear using infrared light communications between a plurality of players is disclosed. These laser tag weapons comprises IR emitters, and IR receivers and are respectively integrated with sensors for acceleration, gyroscopic and magnetic sensor to track tilt, movement and speed of the weapons, and wireless module or data communication linked to communicate with software or apps on mobile or wearable computers or mobile phones. The toy laser tag weapons further comprises at least an IR shooter, IR sensor and movement sensor that can be mounted onto toy sword, bow, glove, shield and spear.

The IR shooter, IR sensor and movement sensors can be incorporated into plastic casings to be a laser tag sword, shield, glove and bow, or an IR device having more than a single role, for instance, having combined roles of laser tag sword and glove, or laser tag sword, glove and gun.

It is an object of the present disclosure disclosed herein to provide an interactive laser tag games system of fight. The system comprises toy laser weapons for each of the players, capable of transmitting and detecting an IR beam of light for use in a game; a wireless module or data communication linked to communicate with software or apps on a mobile display device loaded with web-based software; a server for the login of the player of the game; and a Global Positioning System (GPS) use for providing locations of the players, of which the GPS data are made available to the players, wherein the web-based software operating on the mobile display device calculates and determines hit by a player being registered, and plays a sound and visual effects of the toy laser weapons on the mobile display device, and generates a Graphical User Interface that displayable on the mobile display device kept with the players so as to enhance the effects of the game.

It is another object of the present invention to provide an interactive laser tag games system comprising the steps of providing each play participant with a toy laser tag weapon capable of transmitting an IR beam of light through an infrared lens and a mobile display device; monitoring the location of opponents (players) indicated on the mobile display device; waving the weapon directed at the opponent to shoot IR beams at the opponent and/or activating a switch on the screen of the mobile display device, and/or exerting a pressure or rubbing action on the contact surface or a rapid movement or shaking of the device or the mobile display device; and firing the weapon onto an on-sight opponent with the toy laser weapon by triggering a button or a trigger on the weapon; wherein firing by pressing the trigger provided on the weapon triggers a command to the mobile display device to vibrate and play a sound file downloaded from the server to simulate the appropriate sound, and LED light flashes at the lens, indicating that shooter has been triggered.

Yet another object of the present invention is to provide an interactive laser tag system for entertaining multiple play participants comprising: a toy laser weapons for each of the players, capable of transmitting and detecting an IR beam of light for use in a game; a wireless module or data communication linked to communicate with software or apps on a mobile display device loaded with web-based software; a server for the login of the player of the game; a Global Positioning System (GPS) use for providing locations of the players, of which the GPS data are made available to the players; and tag play screen comprising a plurality of lined rows and columns of integrated IR receivers and IR emitters with light dependent resistors with embedded light dependent resistor, wherein the tag play screen is connected via Bluetooth or WLAN to the mobile display device, wherein the web-based software operating on the mobile display device calculates and determines hit by a player being registered, and plays a sound and visual effects of the toy laser weapons on the mobile display device, and generates a Graphical User Interface that displayable on the mobile display device kept with the players so as to enhance the effects of the game.

Still another object of the present invention is to provide a method for providing an interactive game, the method comprising the steps of: a. providing each play participant with a toy laser tag weapon capable of transmitting an IR beam of light through an infrared lens and a mobile display device; b. connecting a tag play screen to the mobile display device that registers the player at the same serve on the same game via Bluetooth or WLAN; c. activating the tag play screen by choosing a computer-animated figures provided by mythical theme to fight against; d. waving the weapon directed at the opponent to shoot IR beams at the opponent and/or activating a switch on the screen of the mobile display device, and/or exerting a pressure or rubbing action on the contact surface or a rapid movement or shaking of the device or the mobile display device and, e. firing the weapon onto the figures with the toy laser weapon by triggering a button or a trigger on the weapon; wherein firing by pressing the trigger provided on the weapon triggers a command to the mobile display device to vibrate and play a sound file downloaded from the server to simulate the appropriate sound, and LED light flashes at the lens, indicating that shooter has been triggered.

Another object of the present invention is to provide a method for providing an interactive game using a toy laser tag spear, bow, shield, glove and sword of the system, comprising the steps of a. providing toy laser weapons including a toy laser tag spear, bow, shield, glove and sword for each of the players, capable of transmitting and detecting an IR beam of light for use in a game, wherein the toy laser weapons are connected to a handphone; b. connecting the tag play screen to a mobile display device that registers the players at the server; c. activating the tag play screen and mythical theme with various computer-animated figures and an anime character being chosen for the game; d. triggering IR beams using the toy laser tag gun and sword at the animated anime character on the tag play screen, wherein the player uses the laser tag sword to kill the anime character.

Yet a further object of the present invention is to provide a method for providing an interactive game using a toy laser tag gun and sword of the system, comprising the steps of a. providing toy laser tag gun and sword for each of the players, capable of transmitting and detecting an IR beam of light for use in a game, wherein the toy laser tag gun and the sword are connected to a handphone; b. connecting the tag play screen to a mobile display device that registers the players at the servers; c. activating the tag play screen and mythical theme with various computer-animated figures and urban warriors being chosen for the game; d. triggering IR beams using the toy laser tag gun and sword at the animated urban warrior on the tag play screen, wherein the player uses the laser tag sword to kill the invading urban warriors at close proximity.

Yet another object of the present invention is to provide an interactive game, wherein different types of weapons can be used in the game, and the game play permits laser tag players to start the game play even at a distance away from each other using the software via mobile device display, and the play allows a player to kill the opponent with a single blow at close proximity through use of tag sword or other toy laser tag weapon.

Still another object of the present invention is to provide an interactive game, wherein the IR beam is directed simultaneously at more than one receiver attached to the body of the player with accuracy, such that the players are compelled to physically move around rather than just through the movement of a game.

Another object of the present invention is to provide an interactive game, wherein the software that initiates and activates the tag screen is self calibrated to minimise rebounding of the IR beams, and similarly, the weapons used together with the tag screen play is self calibrated through the software to ensure that IR rebounding off the area of play is minimised.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is a schematic diagram of an interactive laser tag system in accordance with the preferred embodiment of the present invention.

FIG. 2 is a schematic diagram of an interactive laser tag system in accordance with another preferred embodiment of the present invention, wherein sword and shield are used by players in the game.

FIG. 2A is a schematic diagram of an interactive laser tag system in accordance with another preferred embodiment of the present invention, wherein bow and shield are used by players in the game.

FIG. 2B is a schematic diagram of an interactive laser tag system in accordance with another preferred embodiment of the present invention, wherein spear and shield are used by players in the game.

FIG. 2C is a schematic diagram of an interactive laser tag system in accordance with another preferred embodiment of the present invention, wherein toy guns are used by players in the game.

FIG. 2D is a schematic diagram of an interactive laser tag system in accordance with another preferred embodiment of the present invention, wherein glove and shield are used by players.

FIG. 3 is a perspective view of shooter having a triggering mean and an emitter in accordance with the present invention.

FIG. 4 is a perspective view of sensor having a IR receiver enclosed by a plastic casing in accordance with the present invention.

FIG. 5 is a perspective view of a toy gun mounted with a shooter having a triggering means in accordance with the preferred embodiment of the invention.

FIG. 6 is a perspective view of a laser tag toy glove having a triggering means in accordance with the preferred embodiment of the invention.

FIG. 7 is a schematic view of a bow in accordance with the preferred embodiment of the invention.

FIG. 8 shows schematically the views of a shield, a sword and a mobile display device in accordance with the present invention.

FIG. 9 shows schematically players holding a toy laser tag spear in accordance with the present invention.

FIGS. 10 and 11 schematically show the laser tag screen with animated features in accordance with the present invention.

FIG. 12 is a flowchart indicating the triggering of weapon and the corresponding actions of the mobile display device and server in accordance with the present invention.

FIG. 13 is a flow chart showing the game being played in accordance with the present invention.

### DETAILED DESCRIPTION OF THE PREFERRED EMBODIMENTS

In the following detailed description of the invention, numerous specific details are set forth in order to provide a thorough understanding of the invention. However, the invention may be practiced without these specific details. In other instances well known methods, procedures, components, etc. have not been described in detail so as not to unnecessarily obscure aspects of the invention.

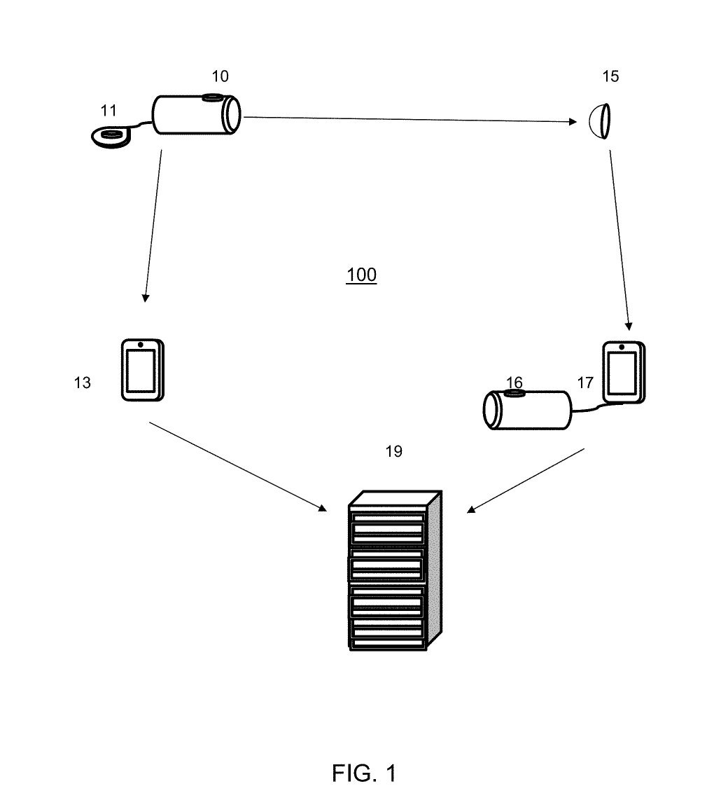

Referring to FIG. 1, an interactive laser tag system 100 in accordance with the present invention is illustrated. The interactive laser tag system 100 for entertaining multiple play participants or players comprises a toy laser weapon (shooter) 10, a wireless module or data communication 13, 17, a server 19 being installed with GPS functions. The toy laser weapon 10 includes toy laser tag sword 40, bow 80, shield 60, glove 110 and spear 112 which are capable of transmitting and detecting an IR beam of light for use in a game. In a preferred embodiment of the present invention, these laser tag weapons 10 contain IR emitters and IR receivers and are integrated with acceleration, gyroscopic and magnetic sensor, embedded microcontroller to sense the movement and speed of the weapons.

The wireless module or data communication 13, 17 of the present invention is linked to communicate with software or apps on a mobile display device such as a handphone 13, wearable mobile computers or the like. Each of the laser tag weapons 10 mentioned above includes at least an IR shooter, IR sensor and movement sensor to be mounted onto toy sword 40, bow 80, shield 60, glove 110 and spear 112. These weapon components can be incorporated into plastic casings for inserting a laser tag sword 40, glove 110, spear 112, shield 60 and bow 80. The IR shooter 10 according to the present invention carries IR emitters, IR receivers, wireless module, acceleration, gyroscopic and magnetic sensors, and an embedded microcontroller, while the IR sensor 15 contains IR receivers, acceleration, gyroscopic and magnetic sensors, and wireless Bluetooth or WLAN module. In the preferred embodiment, the IR sensor 15 can include vibration motor which generates vibration when a beam of IR from the emitter is received, and the IR sensor 15 may also be integrated into gloves, jacket, belt and the like.

In the present invention, mobile display device 17 includes handphone and wearable mobile computers, which can play sound files and create vibration in response to sensor 15 receiving an IR beam from the shooter 10.

In accordance with the present invention, each player has a mobile display device 17 such as a computer or phone or a wearable computer, of which the data is linked with a plurality of shooters 10 and sensors 15. The web-based software operating on the mobile display device such as computer or phone 13 is used to track the types of weapons being used, the types of shots fired or strikes on its opponents, the mode of the weapons, and the number of hits received from the opponents (other players).

Using a Global Positioning System (GPS) of the mobile display device 13/17, and data derived from the acceleration, gyroscopic and magnetic sensor embedded in the toy laser weapons, the web-based software calculates and determines whether the hits by the players are registered, plays the sound and visual effects of the laser tag sword 40, shield 80, glove 110, spear 112 and bow 60 on the mobile display device or phone 13, and generates a Graphical User Interface (not shown) that can be displayed on mobile devices or mini LCD hooked on glasses or visor worn by the players to enhance the effects of the game.

The present invention can be extended to create laser tag Ninja style weapons allowing the throwing of handheld weapons like knives, spikes and stars during laser tag plays via the laser tag glove 110 which will house IR emitters and IR receivers integrated with acceleration, gyroscopic and magnetic sensor, and microcontroller to sense the movement and speed, mobile display device and vibration motors. The toy laser equipment described above can be used to play against animated anime characters including warriors, ninjas, robots, aliens and mythical creatures projected on a special screen known as tag play screen that have embedded IR emitters and receivers allowing laser tag gaming between the players and the projected computer-animated figures.

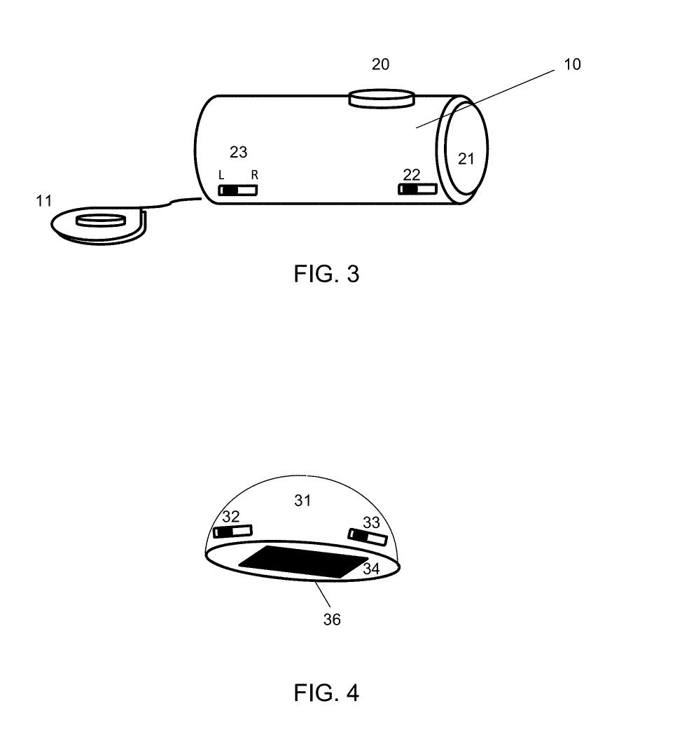

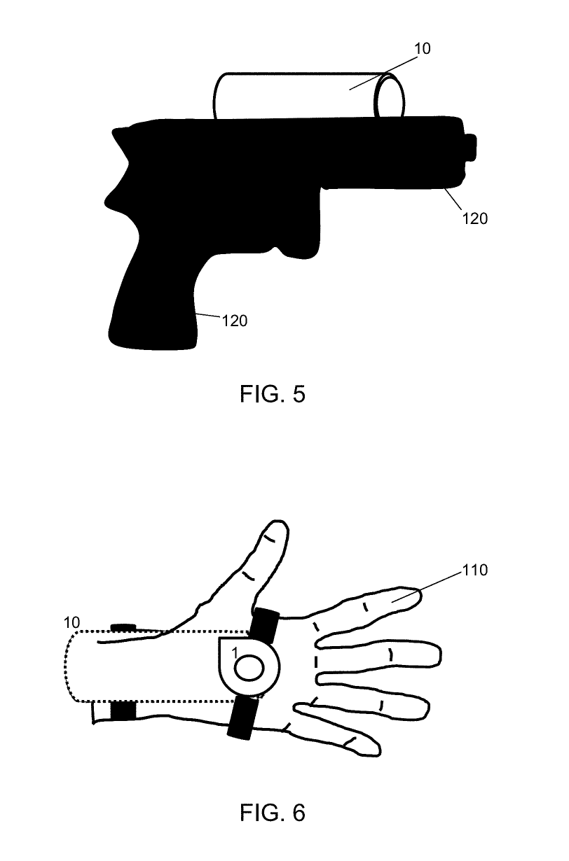

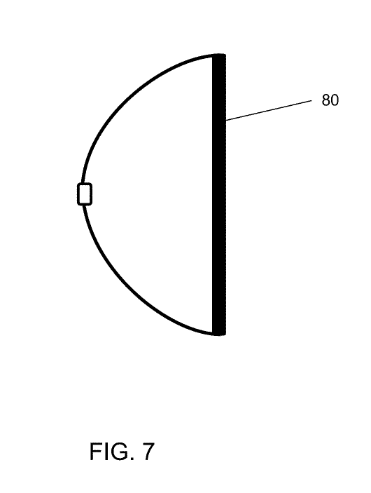

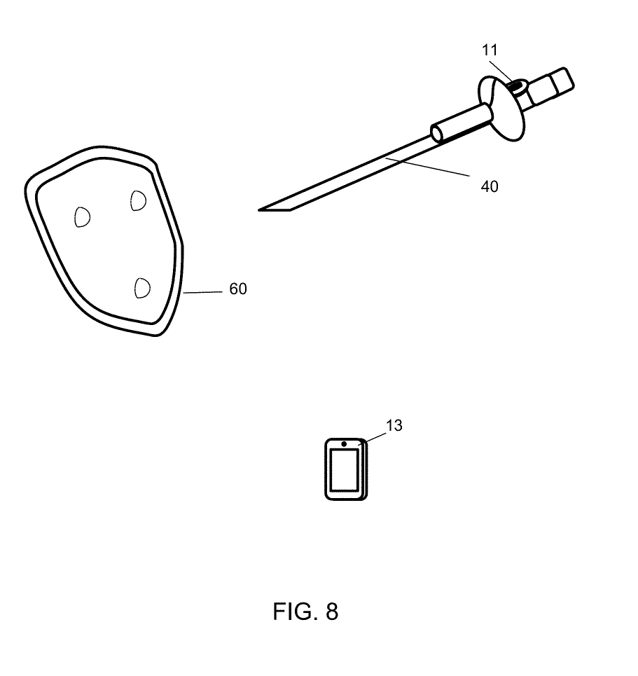

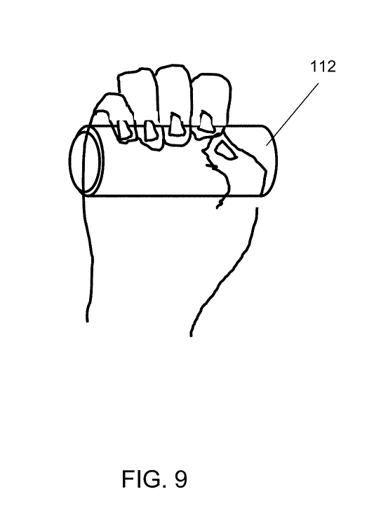

In accordance with the present invention, the toy laser weapons for each of the players, capable of transmitting and detecting an IR beam of light for use in a game through an infrared lens. Referring to FIG. 3, the shooter 10 is operated by battery and is connected to a mobile computer or a handphone via Bluetooth or WLAN. When a firing is required, the shooter 10 requires pressing the trigger 11 or button trigger or the like. Before the starting of the game, the power of the IR beams emitted is calibrated to a desired range to ensure there is no rebound. When the trigger 11 is pressed, a command is triggered to the mobile display device 13 to vibrate and play a sound file downloaded from the server 19 to simulate the appropriate sound and LED light will flash at the lens to stimulate firing, such that the user knows that the shooter 10 has been triggered. The shooter is provided with an ON/OFF 22 switch and a L/R switches 23 to allow the firmware to establish connection via Bluetooth or WLAN to the handphone 13 that operates on IOS or Android. The shooter 10 also carries a battery, wireless module (Bluetooth or WLAN), IR emitter, lens and microprocessor.

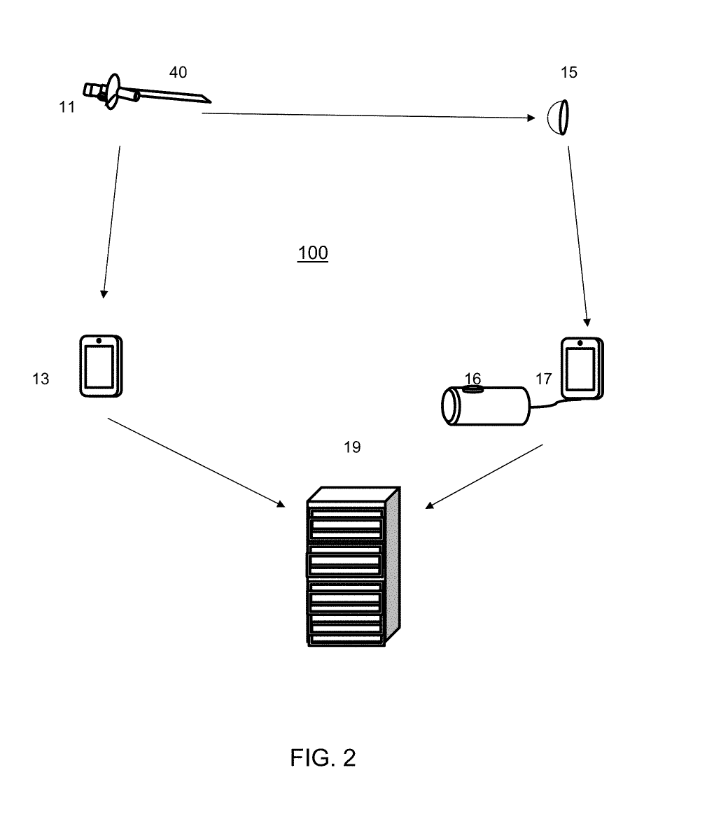

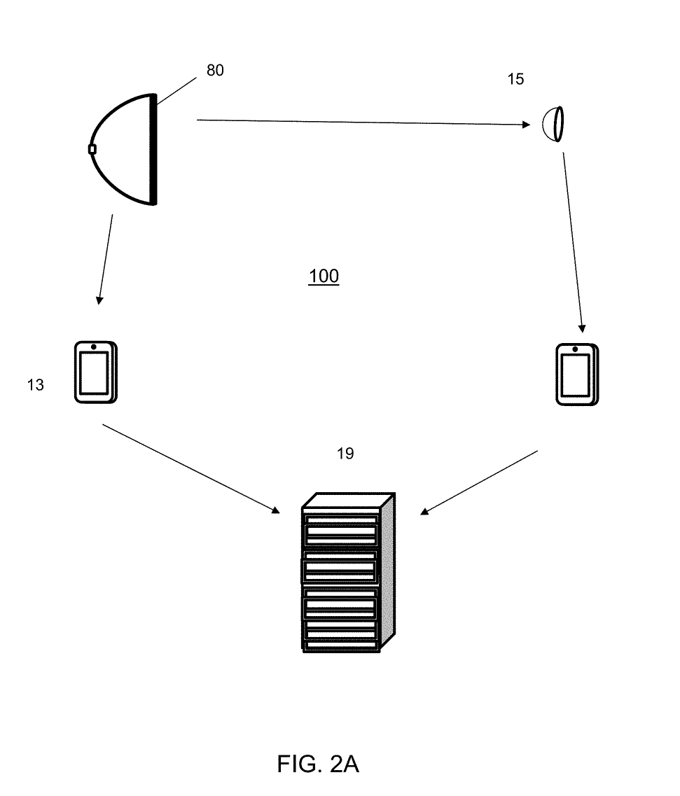

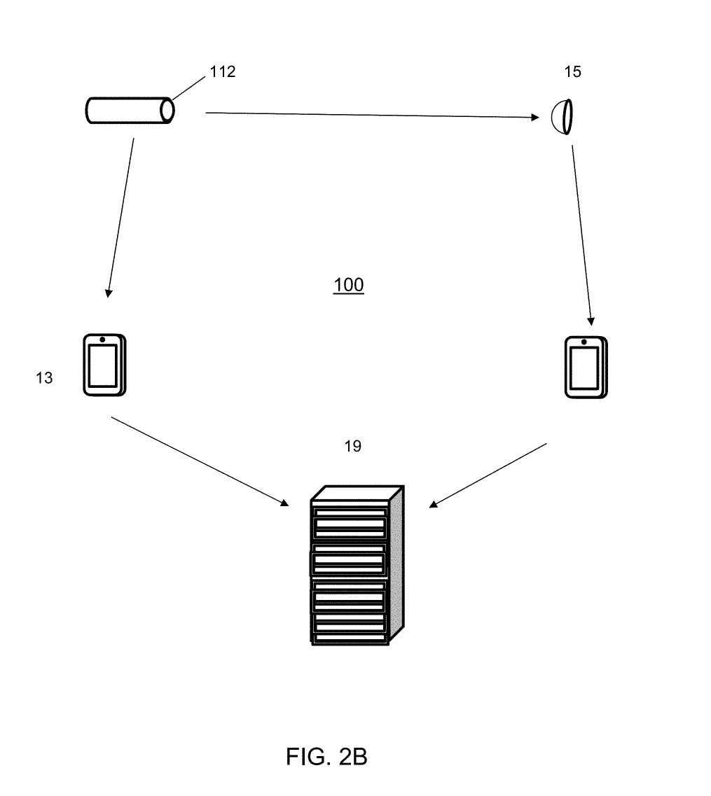

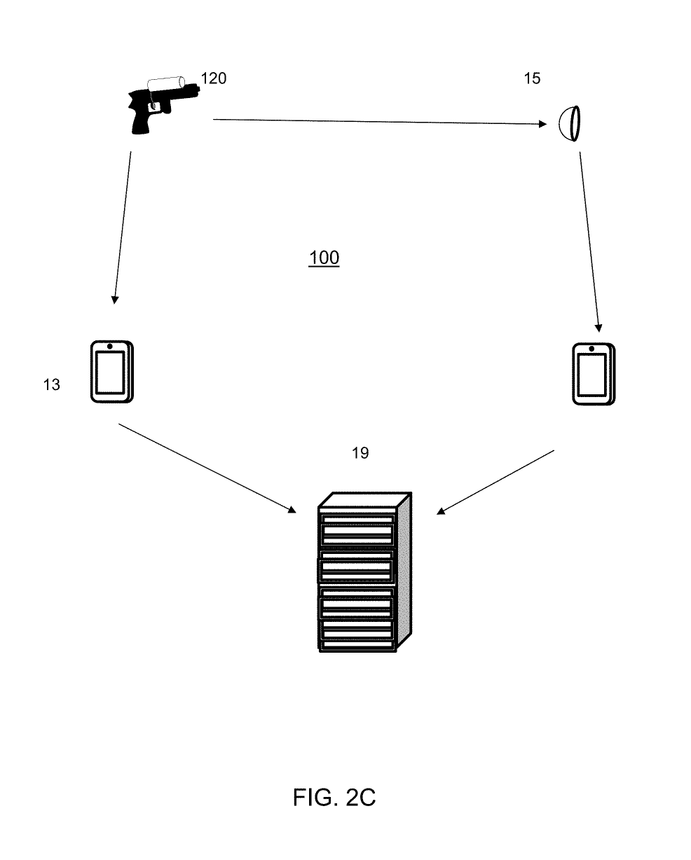

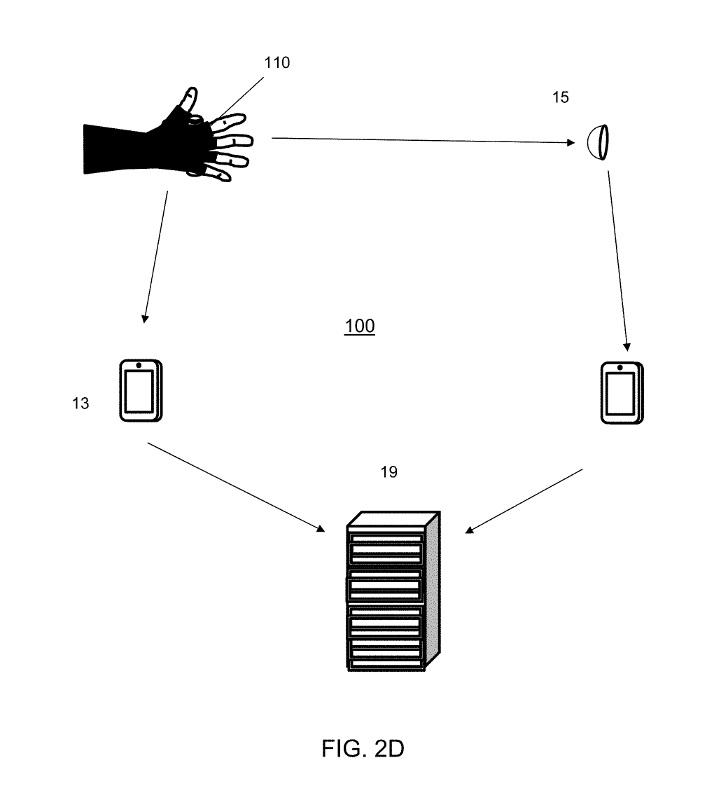

In FIG. 2, there is shown another preferred embodiment of the present invention, a toy laser tag sword 40 is employed in the system. The toy laser tag sword 40 is capable of transmitting an IR beam of light for use in a laser tag gaming. The laser tag sword 40 is connected to a mobile display device 13 (which is a mobile computer or a handphone) via Bluetooth or WLAN module. To fire the laser tag sword 40, a trigger on the sword has to be triggered or the acceleration of the sword reaches a certain value that automatically triggers the firing, while waving the sword 40 directed at the opponent to shoot IR beams being fired in burst with calibrated time intervals and the power of the IR beams emitted is calibrated to a desired range.

When the trigger of the sword 40 is pressed, the command to the mobile display device 13 is also triggered to play a sound file to simulate the sound produced by an attacking sword 40. In accordance with the preferred embodiment of the present invention, a variety of the range and burst rate of the IR beams controlled via the use of mobile computer or handphone or mobile display device 13 through a dedicated Graphical User interface have been contemplated to simulate the power of the sword 40. There is a battery (not shown), wireless module, IR emitter, lens and microprocessor are embedded within the laser tag sword 40. The wireless module includes Bluetooth or WLAN. There are a plurality of grip, handle and sword blade are also been contemplated for the laser tag swords 40.

In the present preferred embodiments, a wireless module or data communication linked to communicate with software or apps on a mobile display device 13 loaded with web-based software is used. As mentioned, the wireless module includes Bluetooth or WLAN. The server 19 in accordance with the present invention, is used to provide sound files to simulate an appropriate sound and LED light (that will flash at the lens).

In FIG. 2A, there is shown another further embodiment of the present invention being a toy laser tag bow 80 capable of transmitting IR beam of light for use in a laser tag gaming. The tag bow 80 is connected to mobile computer or handphone 13 via Bluetooth or WLAN module, and firing of the laser tag bow 80 requires the pulling of the string while aiming at the opponent to direct the IR beam. The power of the emitted IR beam can be altered via the use of mobile computer or handphone 13 through a dedicated Graphical User interface to simulate an arrow carrying a fireball. A trigger device 11 (FIG. 4) containing accelerometer or Measurement Inertial Sensor or any other smart sensor will be clipped on the string of the bow 80 to trigger the shooting of the arrow. The trigger of the shooting of the arrow will also trigger a command to the mobile computer or handphone to vibrate and play a sound file to simulate the appropriate sound produced by a shooting arrow. The sound is generated from the server 19 connected to the system. Embedded within the laser tag bow 80 is battery, wireless module (e.g. Bluetooth or WLAN), IR emitter, lens, microprocessor and accelerometer or Measurement Inertial Sensor or any other smart sensor. A variety of grip, aiming sight and bow have also been contemplated for the laser tag bow 80.

In FIG. 2B, there is shown in another preferred embodiment of the present invention, a toy laser tag spear 112 that is capable of transmitting an IR beam of light for use in a laser tag gaming is employed. The spear 112 is connected to a mobile display device 13 via Bluetooth or WLAN module. It will require pressing the trigger of the toy laser tag spear 112 while aiming the spear 112 directed at the opponent to shoot the IR beams being fired in burst with calibrated time intervals and the power of the IR beams emitted is calibrated to a desired range. When the trigger is pressed, a command is triggered to the mobile display device 13 to play a sound file to simulate the appropriate sound by an attacking spear. In another preferred embodiment, the data on the maximum velocity and bearing of the throw can be determined by using accelerometer, measurement and inertial sensor or smart advanced sensor which will provide the information on maximum acceleration of the spear, the time duration when this acceleration is applied and the direction of the throw.

Throughout the game in accordance with the present invention, a variety of the range and burst rate of the IR beams controlled via the use of the mobile display device 13 through a dedicated Graphical user interface have been contemplated to simulate the power of the spear. A variety of grip, handle and spear tip have also been contemplated for the laser tag spear 112.

Referring to FIG. 2C, there is shown another preferred embodiment of the present invention is to provide a toy laser tag gun 120 capable of transmitting an IR beam of light for use in a laser tag gaming, which is connected to mobile computer or handphone 13 via Bluetooth or WLAN module. Firing of the laser tag gun 120 requires the pressing of a trigger directed at the opponent to shoot IR beams being fired in burst with calibrated time intervals and the power of the IR beams emitted is calibrated to the desired range.

Referring to FIG. 2D, there is shown another preferred embodiment of the present invention is to provide a toy laser tag glove 110 capable of transmitting an IR beam of light for use in a laser tag gaming, which is connected to mobile computer or handphone 13 via Bluetooth or WLAN module. The laser tag glove 110 houses the IR emitters and IR receivers integrated with acceleration, gyroscopic and magnetic sensor, and microcontroller to sense the movement and speed, and can house the mobile display device 13. Firing of the laser tag glove 110 requires the activating a switch on screen of mobile display device 13, and/or exerting pressure or rubbing action on contact surface to activate a selection of weapons like spike, knife, fireball that appears on the display of the mobile display device 13 like handphone before being fired towards the target by rapid movement and pressure on a sensor trigger embedded in the glove 110. A variety of designs using fabrics and plastics to incorporate the electronic components has been contemplated for the laser tag glove 110.

Referring to FIGS. 3 and 4, the present invention also provides toy laser tag sensor 15 capable of receiving IR beam of light for use in a laser tag gaming. The sensor 15 will be connected to mobile computer or handphone 13 via Bluetooth or WLAN module. The laser tag sensor 15 are positioned appropriately on the garments worn by the gamer, not excluding cap, shoulder, skeleton battle order, belt to ensure that attacks made by laser tag sword 40, bow 80, glove 110 and spear 112 can be picked up. When the sensor 15 registers a hit from the IR beam emitted by laser tag sword 40, bow 80, glove 110 and spear 112, a string of data modulated or encoded onto a carrier frequency is being registered on the sensor 15 which is then transmitted via Bluetooth to the mobile computer or handphone 13 to the server 19, and a sound file to simulate that gamer has been hit, and a data string will be passed to the server 19 indicating who the shooter is, so that the server 19 will register the hit for the shooter, and a sound file will be played at the shooter to indicate a successful hit. There is an ON/OFF switch 32 and a UR 33 switch to allow the firmware to establish connection via Bluetooth or WLAN to the handphone 13 that operates on IOS or Android. LED light will flash at the plastic casing 31 if it registers a hit from the shooter. The casing 31 can be adhered with a Velcro or sticky tape 36 that can be stuck to clothing, arm belt or wrist belt. Embedded within the sensor 15 are battery, wireless module (e.g. Bluetooth or WLAN), IR receiver, vibration motor and microprocessor. A variety of size, material, design and number of IR receivers have also been contemplated for the laser tag sensor 15, including incorporating the electronic components into belt, glove and wearable vest to fulfil the same function as a laser tag sensor 15.

The present invention further relates to a toy laser tag shield 60 mounted with a number of laser tag sensors capable of receiving IR beam of light for use in a laser tag gaming. The sensors will be connected to mobile computer or handphone via Bluetooth or WLAN module. The laser tag sensors mounted on the laser tag shield are spaced appropriately to ensure that attacks made by a laser tag sword, bow and spear can be picked up. When the sensor registers a hit from the IR beam emitted by laser tag sword 40, bow 80, glove 110 and spear 112, a string of data modulated or encoded onto a carrier frequency is being registered on the sensor which is then transmitted via Bluetooth to the mobile computer or handphone 13 to the server, and a sound file to simulate that the directed attack is being blocked. A variety of size, material, design and number of sensors have also been contemplated for the laser tag shields.

The present invention also relates to software or apps in a mobile computer display, which can be a personal computer, notebook, tablet, handphone, smart watch, smart glasses etc. capable of exchanging information to and fro the laser tag sword 40, bow 80, sword 112, glove 110, shield 60, sensor 15 and gun 120 via Bluetooth or WLAN modules. The current Bluetooth protocol allows up to a maximum of seven slaves per master device; the mobile device 13 using the software or apps is the Master with the laser tag sword 40, bow 80, glove 110, shield 112, sensor 15 and gun 120 as Slaves. Command can be issued by the software or apps by changing the information stored in the laser tag sword 40, bow 80, sword 112, glove 80, shield 60, sensor 15 and gun 120, and hence allowing them to response to the transmitted information via the firmware. In accordance with the present invention, the software or apps allows the erection of shield 60 and in doing so, the sensor 15 connected to the mobile computer 13 will be switched off momentarily, so that no hit can be registered during that period. The software or apps allows the switching of the types of weapons from laser tag sword 40 to gun 120 and vice versa, and the firing modes of the IR beams that will directly affect the rate of firing of the IR beams and the power associated with the firings can be changed via transmitted data string from the mobile display device 13.

The software or apps in accordance with the present invention allows the users to see the locations of each other using the GPS inside their mobile display devices 13 such as the handphones, and the distance and bearings between each other will be known. Graphical user interface of the software or apps allows the players to launch missiles, artillery, satellite laser beams, sorcery lightning strikes and rocks onto each other to register hits, and players are able to erect their shields 60 to neutralize the hits coming in. Appropriate sound files will be played on the mobile display device 13 of the launched weapons and also for those being targeted if there is a near miss or a hit. Graphical user interface of the software or apps allows simulated aircraft or UFOs to hunt for target. Appropriate vibration and sound files are played on mobile display device like handphone to simulate the flight of the aircraft or UFOs, when they fly over the players.

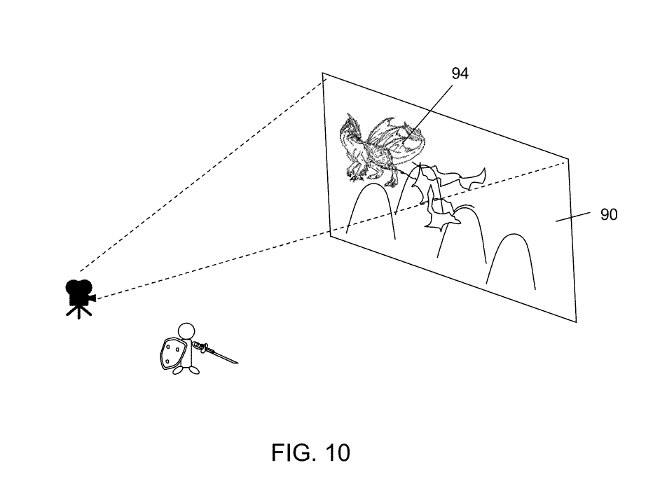

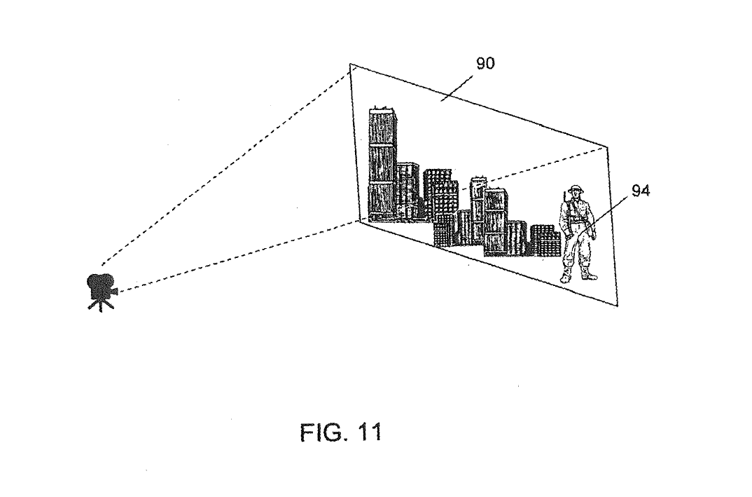

In FIG. 10, there is shown another preferred embodiment of the present invention to provide a tag play screen 90 that comprises lined rows and columns of integrated IR receivers and IR emitters embedded light dependent resistors. The tag play screen 90 is connected via Bluetooth or WLAN to a mobile display device 13, which runs a software or apps to enable the screen to become alive. The tag play screen 90 is able to emit and receive IR beams. The screen 90 on the mobile display device 13 is being projected via any projector 92 onto the tag play screen 90 in a dimly lighted room. During activation of the tag play screen 90, a white screen is projected onto the tag play screen 90 to identify the active IR sensors and IR emitters. The IR receivers and IR emitters are activated based on the change in the resistance of the embedded light dependent resistors. The rows and columns of the active IR receivers and IR emitters are matched to the corresponding screen size of the graphic created for the laser tag gaming. For this reason, the projected screen from the projector 92 cannot be larger than the tag play screen 90. Embedded within the tag play screen 90 is electrical plug, port for direct connection to mobile computer, wireless module (e.g. Bluetooth or WLAN), IR transmitters, IR receivers, light dependent resistors and microprocessor. In the present invention the materials used to embed the IR sensors and IR emitters in the tag play screen 90 are IR absorbents, serve to minimise the bouncing of the IR beams in the room. The room is thus preferred to be air-conditioned to cool down the heat generated from the absorption of these IR beams. The strength of the IR beams is also calibrated via the use of software or apps to minimise bouncing of the IR beams in the room.

The present invention further relates to software or apps in a mobile display device 13 that is connected to the tag play screen 90. The server-based software or apps generate and display computer-animated FIG. 94, which serve as targets to be fired on using the toy laser tag weapons. The emitted IR beams from the toy laser tag weapons register hit on the IR receivers embedded the screen generating a score via the server based software.

Hits will be registered when the IR receivers being projected with the animated FIG. 94 are hit by the IR beams, and the animated FIG. 94 will vaporize into bits or otherwise depending on the scenario being played. In another example, the computer-animated FIG. 94 can be replaced by a falling rock, which can be sliced into pieces using the toy laser tag sword 40. In another example, computer-animated FIG. 94 can attack the players by firing their weapons or throwing a spear 112 or spraying balls of fires or electrical shocks on to the players. The attacking action will translate into emission of IR beams by the IR emitters from the tag play screen 90 towards the players in a pre-programmed logarithm to maximize the chance of hitting the players. Appropriate vibrations and sound files will be played on the mobile computers 13 throughout the play.

In accordance with the present invention, there is provided a method for providing an interactive game, the method comprising the steps of: providing each play participant with a toy laser tag weapon capable of transmitting an IR beam of light through an infrared lens and a mobile display device 13; monitoring the location of opponents indicated on the mobile display device 13; waving the weapon directed at the opponent to shoot IR beams at the opponent; and firing the weapon onto an on-sight opponent with the toy laser weapon by triggering a button or a trigger 11 on the weapon; wherein firing by pressing a trigger 11 provided on the weapon triggers a command to the mobile display device 13 to play a sound file downloaded from the server 19 to simulate the appropriate sound and LED light flashes at the lens, indicating that shooter has been triggered.

The present invention also provides an interactive laser tag system for entertaining multiple play participants comprising: toy laser weapons for each of the players, capable of transmitting and detecting an IR beam of light for use in a game; a wireless module or data communication linked to communicate with software or apps on a mobile display device 13 loaded with web-based software; a server for the login of the player of the game; a Global Positioning System (GPS) use for providing locations of the players, of which the GPS data are made available to the players; and tag play screen comprising a plurality of lined rows and columns of integrated IR receivers and IR emitters with light dependent resistors with embedded light dependent resistor, wherein the tag play screen is connected via Bluetooth or WLAN to the mobile display device 13, wherein the web-based software operating on the mobile display device 13 calculates and determines hit by a player being registered, and plays a sound and visual effects of the toy laser weapons on the mobile display device 13, and generates a Graphical User Interface that displayable on the mobile display device 13 kept with the players so as to enhance the effects of the game.

The present invention is a method for providing an interactive game, the method comprising the steps of: providing each play participant with a toy laser tag weapon capable of transmitting an IR beam of light through an infrared lens and a mobile display device; connecting a tag play screen to the mobile display device that registers the player at the same serve on the same game via Bluetooth or WLAN; activating the tag play screen by choosing a computer-animated figures provided by mythical theme to fight against; waving the weapon directed at the figures on the tag play screen and firing the weapon onto the figures with the toy laser weapon by triggering a button or a trigger on the weapon; wherein firing by pressing a trigger provided on the weapon triggers a command to the mobile display device to play a sound file downloaded from the server to simulate the appropriate sound and LED light flashes at the lens, indicating that shooter has been triggered.

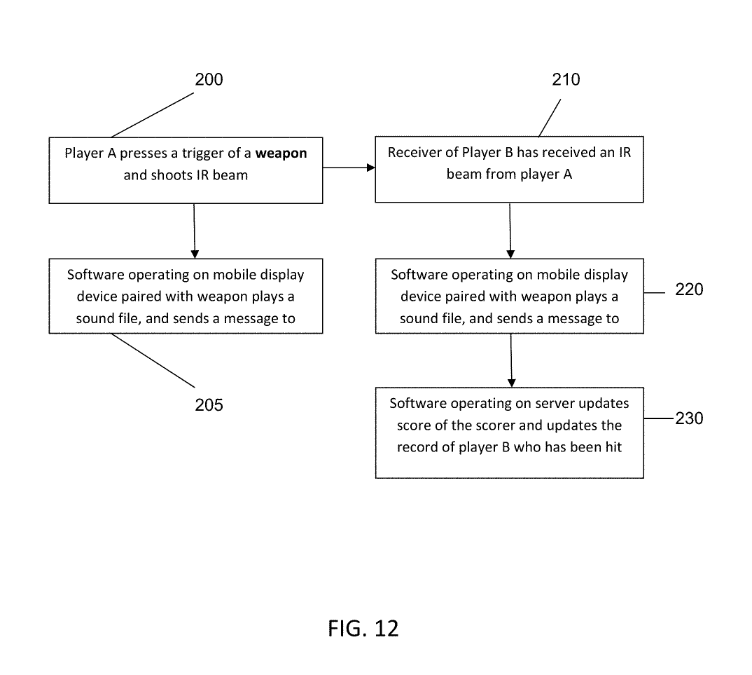

As shown in FIG. 12, there is shown the method of the interactive game in accordance with the present invention. At a distance not visually in sight, players use maps displaying on the mobile display device 13 to check the locations of the opponents (300). The software on the mobile display device 13 is used, the player score points by attacking the opponent while defending against attacks using gaming buttons displayed on the mobile display device 13. (310). At a visual distance, the players use the weapons to shoot IR beams and virtual arrows or bomb to score points against opponents while defending using the shields (320). At distance less than 3-5 meters, players use the swords to beam IR beams that result deadly blow (330).

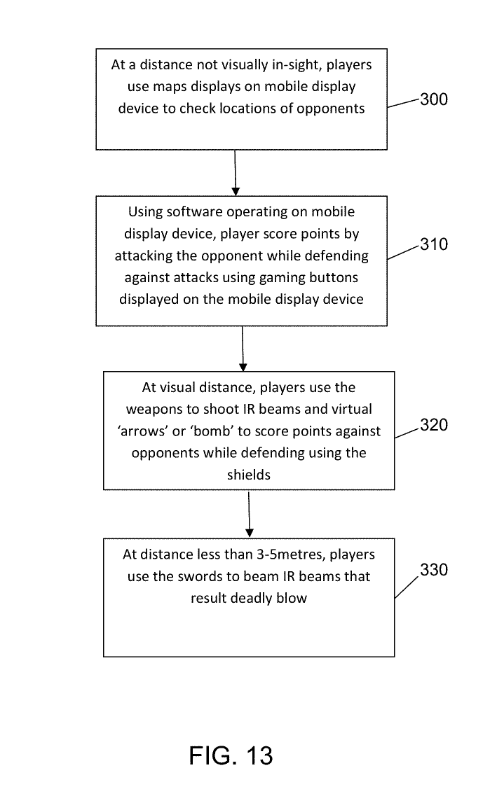

Referring to FIG. 13, there is shown a flowchart showing the process of the interactive game. When a player A presses a trigger 11 of a weapon and shoots IR beam (200), the software operating on a mobile display device 13 paired with the weapon to play a sound file and sends a message to the server (205). At the same time, the receiver of Player B has received an IR beam from player A (210). Then, the software operating on the mobile display device 13 paired with the weapon plays a sound file, and sends a message to the server (220). The software operating on the serves updates the score of the scorer: player A and updates the record of player B who has been hit. (230).

In a preferred embodiment in accordance with the present invention, the players are divided into two teams and each player of the game is provided with a handphone 13 connected to a toy laser tag gun 120, a shield 60 and a sword 40. All the players are first login to the server 19 to play the same game. In the beginning of the game, all the players of each team could watch the players of the other team move into the action via the mobile display device 13. Each player uses the graphical user interface to shoot killer laser beam from satellite laser stations in space. In this game, the killer laser beam emitted down towards the player will have to start at a spot marked by each player, and the number of killer laser beams for each player is limited. The player being attacked is given an early warning which can be heard by the players that the killer laser beam tears through the ground. The players can protect themselves by setting up a protective energy field. When the players of two teams get nearer to each other, the player will not likely to use the killer laser beam since the beam may also hurt the player themselves. The players would start to use their laser tag guns 120 to tag each other and use their toy shields 60 to protect themselves. At close combating, the players use their toy laser tag sword 40 to deal effective blows and kill each other in the game.

In combating game, each player can use the graphical user interface to target each other by flying killer drones over each other and dropping bombs over or target missiles on each other. In the present preferred embodiment, the bombs or missiles launched from the killer drones are controlled by the player using the graphical user interface of the handphone 13. The number of bombs or missiles for each player is limited. Similarly, players being attacked are given an early warning and the players can hear the killer drones flying, and the players can protect themselves by setting up a protective magnetic force field to deflect the shrapnel from the bombs or missiles. In other preferred embodiments, the killer drones can be replaced by fighter helicopters or aircraft where the players can use them to attack each in an air fight, apart from the attacking the players. Subsequently, when they get nearer, the players are not likely use the killer drones or fighter helicopters or aircraft since these devices can hurt them too.

In examples for tag play screen 90, the player is provided with a handphone 13 connected to toy laser tag spear 112, bow 80, glove 110, shield 60 and sword 40. The tag play screen 90 is connected to a mobile display device 13 that registers the player at the same server 19 on the same game. In this game, the tag play screen 90 is activated and mythical theme provides various computer-animated FIG. 94 and the player can choose to fight against the chosen computer animated FIG. 94 including ninja, dragon, monsters, robots, dinosaurs, mythical creatures and alien creatures. Assuming that the players chose a dragon, when the game starts, tag play screen 90 shows the scene moving to simulate player walking across a path in the hills and from afar the players see dragon at a distance flying in the air. If the players have a weapon which is too far to engage the dragon, the words, out of range, appear if the players try to tag it. The players use the graphic on handphone 13 to enhance the range of weapons by using limited sorcery powder given by a sorcerer to ensure that they engage the dragon. The players use the graphical user interface on handphone 13 to use sorcery powder to set up a temporarily protective field. As the players get nearer, the dragon starts to throw rocks at the players. The players need to use the shield 60 to protect them from injuries by the rock. As the rock rolls and dives towards the players, the players need to use the shield 60 to block the attacking. The size of the rock grows and when the rock reaches a certain size, the IR emitters are to tag the players or the players can move away from the computer-animated rock. The dragon which has been tagged by toy laser tag spear 112 or bow 80 will vaporize. The rocks can also be vaporized if the rocks are sliced by the toy laser sword 40, glove 110 or bow 80. There will be a symbol to indicate which weapons could be used on which target based on the distance. The dragon at close range throws fire out from the mouth on the players. The players can dodge by moving away based on the direction of the fire. The player can use shield 60 to protect against the fire and can use the toy laser tag sword 40 or bow 80 to destroy the dragon. Each of the attacking action will coincide with the emission of the IR beams by computer selected IR emitters on the tag play screen 90 in line with the action of the computer-animation 94. The game play involving the use of the tag play screen 90 can be played by single player as well as multiple players.

In another preferred embodiment of tag play screen, the player has a handphone 13 connected to toy laser tag gun 120 and sword 40. The tag play screen 90 is connected to a mobile display device 13 that registers the players at the same server 19 on the same game. In the beginning of the laser tag gaming, the tag play screen 90 is activated and theme provides various animated figures player can choose to fight against, for instance, the player chooses the urban warriors. When the game starts, tag play screen 90 shows the scene moving to simulate player walking across a path to set up a position to take up sniper position. Then, the sound files in the server 19 plays to explain that enemies are coming close and players see fire fights commencing. The players start to see enemy forces approaching as engagement starts. The fights goes into the night, the players use the graphical user interface on handphone 13 to do a night vision goggle (NVG) and the graphics change on screen to NVG. In this game, illumination rounds can be used by using the graphical user interface on handphone 13. At close range, the players use the laser tag sword 40 to kill the invading urban warriors. When the players run out of rounds in their magazines and require loading magazine, the player uses the graphical user interface on handphone 13 to take cover when artillery shells are falling or RPG rockets or grenades are being hurled at the position of the players. Each of the attacking action coincides with the emission of the IR beams by computer selected IR emitters on the tag play screen in line with the action of the computer-animation 94.

In the present invention, the game play permits laser tag players to start the game play even at a distance away from each other using the software via mobile device display 13, and the play allows a player to kill the opponent with a single blow at close proximity through use of tag sword 40.

The pressing of the trigger 11 also initiates a command to the mobile display device 13 or handphone 13 to play a sound file to simulate the appropriate sound produced by an attacking sword. A variety of the range and burst rate of the IR beams controlled via the use of mobile display device 13 or handphone 13 through a dedicated Graphical User interface have been contemplated to simulate the power of the gun 120.

As shown in the preferred embodiment of the present invention, the player has a handphone 13 connected to toy laser gun 120 in the form of tag glove 110. The tag play screen 90 is connected to a mobile display device or computer 13 that registers the player at the same server 19 on the same game. In the beginning of the laser tag gaming, the tag play screen 90 is activated and theme provides various animated FIG. 94 player can choose to fight against. The player chooses one of the characters, for example, ninja warrior. When the game starts, tag play screen 90 shows the scene moving to simulate player walking in a jungle task to save a kidnapped feudal lord. Once set, sound files will play to explain that enemies know that player is coming to save the kidnapped feudal lord, and there are ninja lightning strikes and fire balls being hurled at the player to ensure player quickly move away from their physical static position. The player uses ninja skill to shoot energy shield to destroy the missiles and bombs by firing spurts of laser beams. The player also uses the graphical user interface on handphone 13 to convert the firing spurts of laser beams to a continuous laser sword 40 or laser ball, for example. When the game starts, tag play screen 90 shows the scene moving to simulate player performing ninja movement from one tree to another to move to the house where the kidnapped feudal lord is being held captive, and along the way the player needs to fend off attacks from enemy ninja by destroying them using ninja jutsu, knives, spikes, and sword through the use of laser tag glove. In the game, each of the attacking action will coincide with the emission of the IR beams by computer selected IR emitters on the tag play screen in line with the action of the computer-animation 94. The setting can permit more than 1 players fighting alongside each other.

In the tagging game of the present invention, the IR beam is directed simultaneously at more than one receiver attached to the body of the player with accuracy, such that the players are compelled to physically move around rather than just through the movement of a handheld game controller. Further, in the present interactive laser tag system for entertaining multiple play participants, the software that initiates and activates the tag screen is self calibrated to minimise rebounding of the IR beams, and similarly, the weapons used together with the tag play screen 90 is self calibrated through the software to ensure that IR rebounding off the area of play is minimised.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. An interactive laser tag system for entertaining multiple play participants comprising:
toy laser weapons for each of the players, capable of transmitting and detecting an IR beam of light for use in a game;
a wireless module or data communication linked to communicate with software or apps on a mobile display device loaded with web-based software;
a server for the login of the player of the game; and
a Global Positioning System (GPS) use for providing locations of the players, of which the GPS data are made available to the players, wherein the web-based software operating on the mobile display device calculates and determines hit by a player being registered, and generates vibration, plays a sound and visual effects of the toy laser weapons on the mobile display device, and generates a Graphical User Interface that displayable on the mobile display device kept with the players so as to enhance the effects of the game.

2. The interactive laser tag system of claim 1, wherein the toy laser weapons comprises laser tag sword, shield, glove, spear and bow.

3. The interactive laser tag system of claim 2, wherein the laser tag sword, shield, glove, spear and bow area capable of transmitting and detecting an IR beam for use in a game.

4. The interactive laser tag system of claim 1, wherein the toy laser weapons contains IR emitters and IR receivers.

5. The interactive laser tag system of claim 2, wherein the laser tag sword, shield, spear glove and bow contain IR emitters and IR receivers.

6. The interactive laser tag system of claim 1, wherein the laser tag weapons are integrated with acceleration sensor, gyroscopic sensor, and magnetic sensor to track tilt, movement and speed of the weapons.

7. The interactive laser tag system of claim 3, wherein the laser tag weapons are integrated with acceleration sensor, gyroscopic sensor, and magnetic sensor to track tilt, movement and speed of the weapons.

8. The interactive laser tag system of claim 1, wherein the mobile display devices include wearable computers, mobile phones, mini LCD hooked on glasses or visor worn by players.

9. The interactive laser tag system of claim 1, wherein the laser tag weapons contain at least a sensor selected from the group consisting of IR sensor and movement sensor.

10. The interactive laser tag system of claim 9, wherein the IR shooter contains IR emitters, IR receivers, wireless Bluetooth or WLAN module, acceleration, gyroscopic and magnetic sensors and an embedded microcontroller.

11. The interactive laser tag system of claim 9, wherein the IR sensor contains IR receivers, acceleration, gyroscopic and magnetic sensors, vibration motors, and wireless Bluetooth or WLAN module.

12. The interactive laser tag system of claim 1, wherein the web-based software operating on the mobile display device tracks the types of weapons being used, the types of shots fired or strikes on its opponents, the mode of the weapons and the number of hits received from the opponents.
